(19) United States
(12) Patent Application Publication
(10) Pub. No.: US 2003/0088616 A1
(43) Pub. Date: May 8, 2003

(54) System and method for customer service application customization, integration, and distribution

(75) Inventors: Hirbod Etessami, Beverly Hills, CA (US); Peter Kim, Redondo Beach, CA (US); Jerad Schempp, Beverly Hills, CA (US)

Correspondence Address: Keyvan Davoudian, PILLSBURY WINTHROP LLP, 725 South Figueroa Street, Suite 2800, Los Angeles, CA, 90017, US

(73) Assignee: QUALTE, INC.

(21) Appl. No.: 10/001,020

(22) Filed: Nov. 2, 2001

(51) Int. Cl. G06F 15/16

(52) U.S. Cl. 709/203

(57) ABSTRACT

A system and method are disclosed for electronically creating, customizing, integrating, and distributing an electronic customer relationship management (eCRM) system for e-businesses. The method calls for the distribution of a hosted product to one or more first-level e-business entities which, in turn, customize and resell the product to one or more second e-business entities. The invention achieves its objectives by providing electronic modules that allow interaction, customization, and integration at various stages within the distribution process.

### BACKGROUND OF THE INVENTION

1. Field of the Invention

The present invention relates to the field of electronic customer relationship management (eCRM) via the Internet, and in particular, to a method for electronically creating, customizing, and integrating a customer service system for businesses, whereby customer requests and concerns can be systematically organized and addressed in a time- and cost-effective manner.

2. Art Background

An electronic business, or so-called “e-business”, uses certain tools to connect its critical business systems directly to employees, customers, vendors, and other important entities via the Internet's World Wide Web, thus making information and processes accessible from anywhere using conventional browser software. E-businesses strive to move all processes that require a dynamic and interactive flow of information online. These processes include, without limitation, service and support, managing supply chains, buying and selling, and the like.

Electronic business has many advantages over conventional business processes, including greater information and data exchange, increased speed and efficiency, reduced costs, and the ability to conduct business twenty-four hours a day, seven days a week. On the other hand, the around-the-clock nature of e-business also poses several challenges, chief among them being that of addressing customer inquiries and concerns on a continuous basis. In order to satisfy customers, e-businesses have found it imperative to provide a venue for customers to obtain information and submit requests in an organized manner twenty-four hours a day. At the same time, however, cost-effectiveness necessitates a solution that requires minimal personal involvement by company representatives.

The simplest method used by e-business entities to manage customer informational needs is through the use of a Frequently Asked Questions (FAQ) webpage, which lists questions that are most commonly asked in relation to the entity's business, as well as answers to those questions. An email address is generally provided for customers to send more-detailed questions to the business entity, in anticipation of the business entity providing an adequate and timely response. In practice, such rudimentary means are commonly used by small businesses that may lack the resources needed for installing and implementing a more robust system.

At the other end of the spectrum are very complex eCRM systems that provide more interactive options such as searchable databases, live email “chat” with customer service representatives, and artificial intelligence software that attempts to answer customer inquiries automatically without human interaction. Traditionally, these complicated eCRM systems have proven to be very costly in terms of both dollars, as well as time spent having the system customized and implemented, thus putting such systems beyond the reach of all but the very largest businesses.

Between these two extremes of complexity are “mid-range” eCRM systems which have been developed to provide necessary customer relations functionality, such as FAQ management, email routing, and chat capability to smaller businesses. However, developers of these mid-range eCRM solutions have been faced with the difficulty of reaching a critical mass of smaller companies. Quite simply, marketing on a one-to-one basis to millions of small businesses is a very costly endeavor due, in part, to the amount of time needed to locate and deal with these businesses individually.

One attempt at solving the above-mentioned problem of accessing a large number of smaller companies in a cost-effective manner is to partner with existing “resellers” of e-business services that have already built a customer base of smaller businesses, and to have these reseller partners sell the eCRM system along with their other products and services, thus quickly reaching a broader market. However, resellers generally require that the systems they sell be private labeled with their own brand name, and that systems be customized for their specific needs. In this regard, although it is possible to use conventional methods to separately and individually customize an eCRM system for each reseller involved, in practice, such a scheme requires expenditure of significant amounts of time and money, thus rendering this option impracticable and/or inefficient.

As such, there remains a need to provide a simple, yet effective, application to handle customer support interactions that is not only affordable and easy to customize and install for small to medium-sized e-businesses, but also amenable to mass distribution to the small-to-mid-sized e-business sector. Additionally, a software tool that would systematize the creation, customization and implementation of such a customer support application would be desirable.

The features and advantages of the present invention will become more apparent through the following description. It should be understood, however, that the detailed description and specific examples, while indicating particular embodiments of the invention, are given by way of illustration only and various modifications may naturally be performed without deviating from the spirit of the present invention.

### BRIEF DESCRIPTION OF THE DRAWINGS

FIG. 1 shows an illustration of communication links established between servers, electronic computers and/or devices that may be used in practicing an embodiment of the invented method.

FIG. 2 shows the interaction between the central administrator, account-builder and account-manager modules for a specific client according to one embodiment of the invention.

FIG. 3 is a schematic of the interaction between resellers, clients, and end-users according to an embodiment of the invention.

### DETAILED DESCRIPTION

To address the above-mentioned shortcomings of existing products, an embodiment of the present invention is directed to a method of customer service application distribution, customization, and integration for use in a multi-layered electronic network including a central administrator, a plurality of resellers, a plurality of clients, and a plurality of end-users, in which each of the resellers has a plurality of clients, and each end-user is a consumer of one or more of the clients' products.

It is noted that, in this application, the term “resellers” is used to refer to Internet Service Providers, Web Hosting companies, etc., that have a customer base of companies/e-businesses to which they sell (or resell) online services and/or products. Similarly, the term “clients” is used to refer to companies and/or e-businesses with an online presence that use a reseller's services.

More specifically, the invented method provides for the distribution of an electronic customer relationship management (eCRM) system including an online customer service interface for use by a client and the client's respective end-users. In the “back end”, the eCRM system includes modules (e.g., customized software packages) for allowing electronic communication and interaction among the central administrator, one or more resellers, one or more clients, and one or more of the clients' customers. In the “front end”, the eCRM system enables each said client to create and manage a customer service interface, including FAQ, e-mail, chat, and reporting (i.e., filing of complaints and commendations by customers) capabilities.

In one embodiment, the invention includes a method for distributing an eCRM system from a central administrator to a first e-business entity through a second e-business entity to provide a customer service interface between said first entity and customers of said first entity, wherein the method comprises: (a) providing an eCRM system that is hosted on a server of the central administrator; (b) registering said second entity with the central administrator; (c) providing the second entity with online access to a first module within said system, said first module enabling the second entity to customize said eCRM system; (d) providing the customized system to one or more of the first e-business entities; and (e) providing each one of the first e-business entities with online access to a second module within said system, wherein said second module enables the first entity to create and customize a customer service interface with customers of said first e-business entity.

In one embodiment, the second entity is a web-based reseller, and the first entity is a client of the reseller. Thus, in this embodiment, the method provides an automated, cost-effective, and time-efficient distribution scheme for distributing an eCRM system from the central administrator to a plurality of clients through a plurality of resellers, as well as allowing for web-based customization and integration by resellers and clients along the distribution channel.

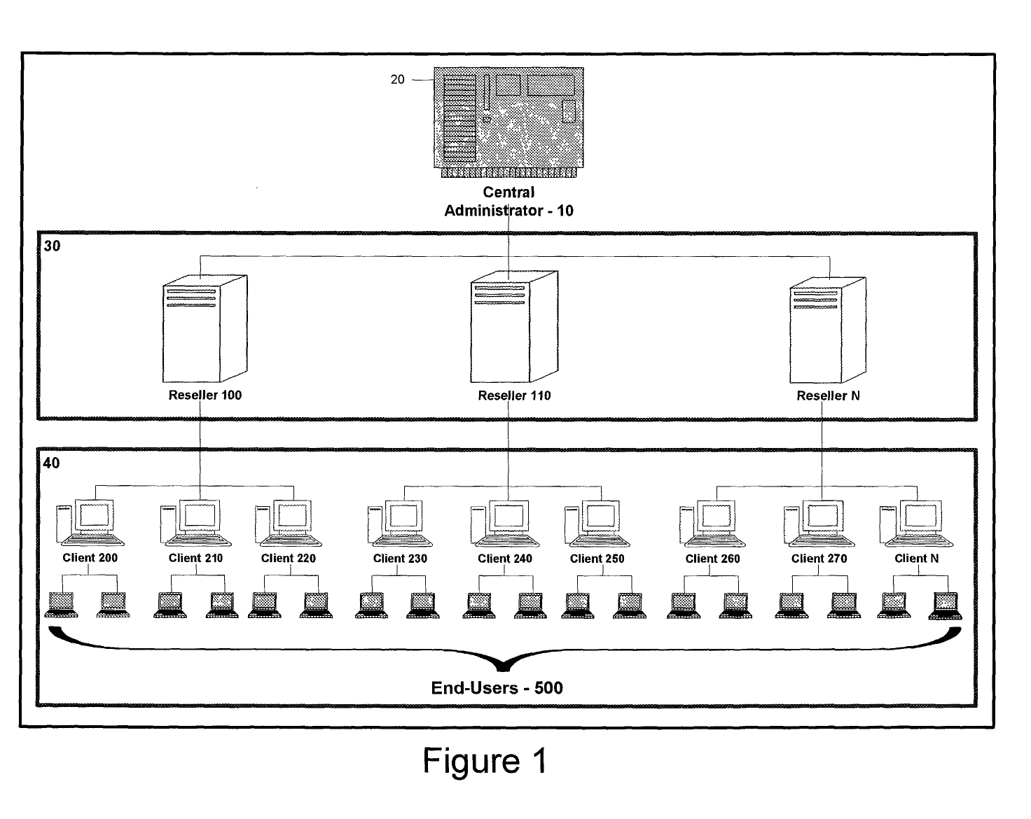

As shown in FIGS. 1-3, the present invention involves the flow of information among four basic entities: (1) the central administrator; (2) one or more resellers; (3) one or more clients; and (4) one or more end-users.

In a preferred embodiment, the process is initiated when a reseller, e.g., reseller 100 in FIGS. 1-3, contacts the central administrator 10 in order to set up an account. The contact is normally made by the reseller 100 establishing electronic communication with the server 20 of the central administrator 10, as when the reseller 100 visits the website of the central administrator 10.

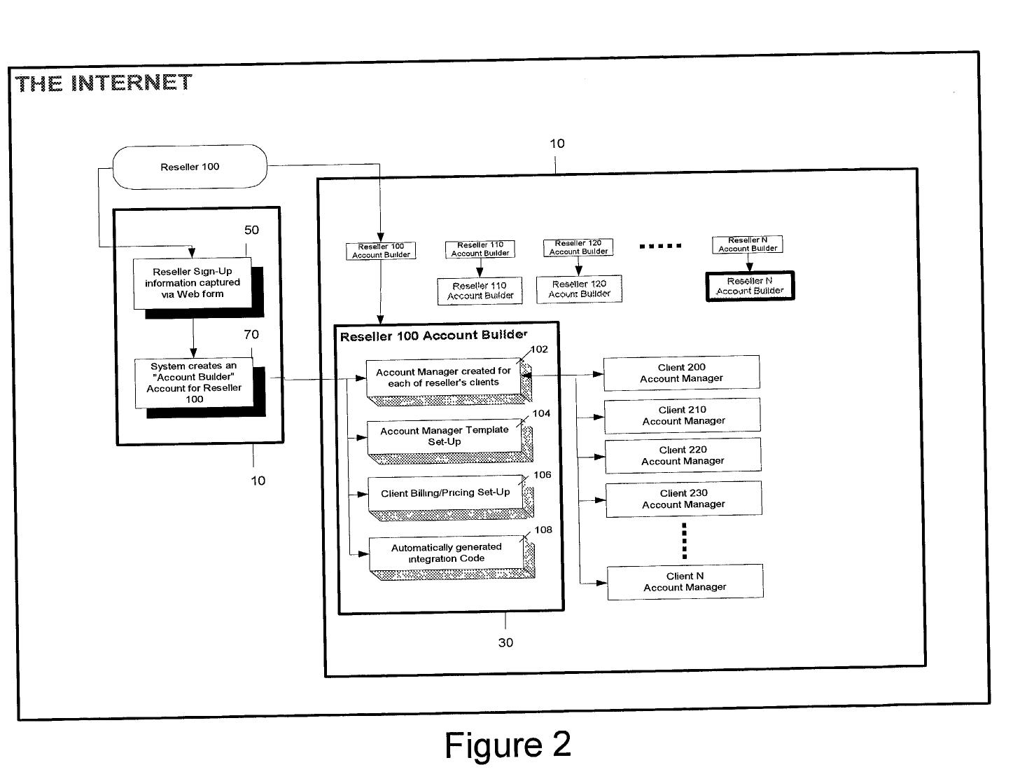

Once electronic contact has been established between the central administrator 10 and the reseller 100, the latter is prompted to provide “sign-up” information identifying the reseller via a web form (see Box 50 in FIG. 2). This typically includes information such as the reseller's company name, location, contact person(s), contact information, billing/invoicing information, and verification information.

The sign-up information is collected and processed in real time. Moreover, at least some of the information (e.g., credit card/billing information) may be verified automatically and in real time as well. Upon verification, reseller 100 is automatically registered with the central administrator 10, which, as depicted in Box 70, uses the sign-up information to automatically create an account-builder account for reseller 100.

The account builder 30 is an electronic module that, in a preferred embodiment, is resident completely on the central administrator's server 20 as a software package. As such, gaining electronic access to, and utilizing, the account-builder 30 is a fully hosted process that, in and of itself, involves no costs to the reseller of storing, maintaining, etc. of any additional software or hardware.

The account-builder module 30 includes a client-manager sub-module and a site-manager sub-module (not shown). As the name implies, the client-manager sub-module is adapted to allow a reseller to manage and administer account information, including pricing/billing, status, and like information for each of its clients. The site-manager sub-module, on the other hand, allows management of the reseller's web site. Thus, for example, the reseller 100 would access the site-manager sub-module to customize and private label the account-builder module, so that it can be integrated into the reseller's product and/or service line, and resold as one of the reseller's products and/or services.

In a preferred embodiment, also completely resident on the central administrator's server 20 as a software package is an account-manager module 40. In practice, once a client, e.g., client 200, has engaged the services of the reseller 100 (such as through establishing electronic contact with the reseller's website) for setting up an eCRM interface, reseller 100 accesses the account-builder module 30 to create an account-manager account for the client 200. In an alternative embodiment, the client 200 can create its own account-manager account automatically by registering on the reseller's website, in a manner similar to that used by the reseller 100 to automatically register with the central administrator 10 (as was described previously).

As shown in FIG. 2, an account-manager template 104 is also set up, whereby reseller 100 can upload its company logo and select a color scheme for each of its account-manager client accounts. In addition, the reseller 100 uses the account-builder module 30 to set up the pricing/billing scheme 106 for client 200. Lastly, an integration code 108 is automatically generated, which allows reseller 100 to add a link to its website that provides client 200 with access to its account-manager module.

With the account-manager account set up for the client 200, the client 200 now has electronic access to the eCRM system and, more specifically, to the account-manager module for creating, customizing, implementing, and managing its customer service interface to be used by its customers.

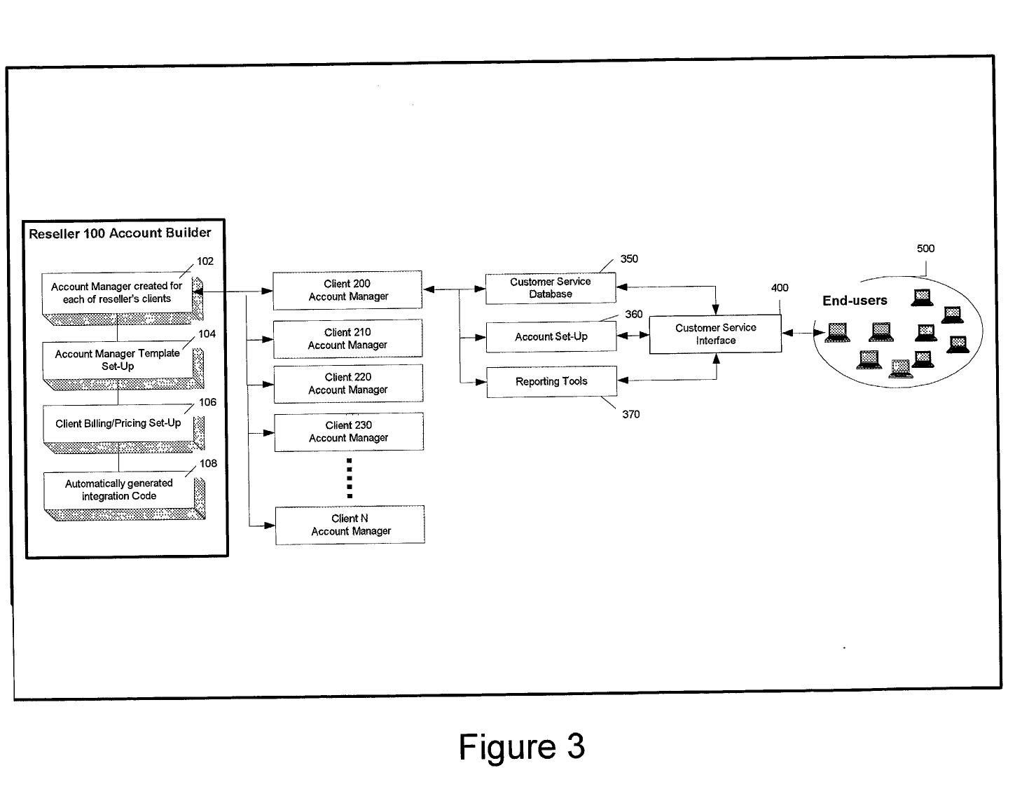

FIG. 3 shows the interaction between a typical client 200 and each of the client's customers (referred to hereinafter as “end-users”). Once an account-manager account 360 has been set up for client 200, the client is able to electronically access, utilize, and administer a customer service database 350, as well as a set of reporting tools 370, that provide functionality and support for the customer service interface 400. Thus, using the account manager 40, the client 200 is able to view, e.g., complaints/compliments that an end-user 500 might have submitted through the client's customer service interface 400.

As is apparent from the above description, having access to the account-builder module 30, and being able to offer access to the account-manager module 40 to every client 200, the reseller 100 is able to function, in effect, as the “central administrator”. However, the final cost to each client is considerably lower than with conventional modes of distribution.

To begin with, the reseller 100 typically has an established base of clients 200. As such, it costs the reseller much less to market and sell the eCRM system to a plurality of clients than if the central administrator were to market and sell the system to the same number of clients on an individual basis. In addition, the marketing that the central administrator does have to do is aimed at a considerably smaller number of targets (i.e., resellers) than if it were to target (a considerably larger number of) clients directly. Therefore, the invented method described herein enables each client 200 to establish a customer service interface at substantially reduced costs.

In addition, because, in a preferred embodiment, the eCRM system, including the account-builder module 30 and account-manager module 40, are hosted on the server 20 of the central administrator 10, there are no additional software or hardware storage, maintenance, etc. costs to either the reseller or the resellers' clients, again resulting in lower costs.

Moreover, with the instant invention, each reseller 100 is able automatically register with the central administrator 10 online, the reseller is able to customize and sell the eCRM system to each of its clients online, and each client 200 is able to create, customize, and manage its customer service interface online. As such, the invention provides a method of distribution and implementation that provides an eCRM system that is much less expensive than would be available through conventional distribution schemes, while, at the same time, it allows full hosting, automation, and customization, thus resulting in further efficiencies in time and costs.

It will be apparent to the person skilled in the art that embodiments of the present invention are not limited to specific embodiments disclosed herein. Thus, the present invention is intended to encompass all of the embodiments disclosed and suggested herein as defined by the claims appended hereto and any equivalents thereof.

What is claimed is:

1. A method for distributing an electronic customer relationship management (eCRM) system from a central administrator to a first e-business entity through a second e-business entity to provide a customer service interface between said first entity and customers of said first entity, the method comprising:
a. providing an eCRM system that is hosted on a server of the central administrator;
b. registering said second entity with the central administrator;
c. providing the second entity with online access to a first module within said system, said first module enabling the second entity to customize said eCRM system;
d. providing the customized system to one or more of the first e-business entities; and
e. providing each one of the first e-business entities with online access to a second module within said system, wherein said second module enables the first entity to create and customize a customer service interface with customers of said first e-business entity.

2. The method of claim 1, wherein said registration step is accomplished automatically by accessing a website of the central administrator and providing identifying information of the second entity online.

3. The method of claim 1, wherein said second entity is a web-based reseller and said first entity is a client of said reseller.

4. The method of claim 3, wherein said first module is an account-builder module that enables said reseller to create, implement, and manage an independent account for each of the reseller's clients.

5. The method of claim 4, wherein said second module is an account-manager module that enables each client to administer, manage, and address input that is provided by the client's customers through the client's web-based customer service interface.

6. The method of claim 1, wherein said eCRM system, including said first and second modules, are hosted substantially fully on one or more servers of the central administrator.

7. In a multi-layered electronic network including a central administrator, a plurality of resellers, a plurality of clients, and a plurality of end-users, in which each said reseller has a plurality of clients and each said end-user is a consumer of one or more of said clients' products, a method for providing an electronic customer relationship management (eCRM) system including an online customer service interface between each said client and the client's respective end-users, the method comprising:
a. providing a web-based account-builder module hosted on the central administrator's server;
b. accessing said central administrator's website through a graphical user interface (GUI) window to provide sign-up information for each reseller;
c. in real time, automatically verifying said sign-up information, automatically registering each reseller with the central administrator, and automatically creating an independent account-builder account for each said reseller;
d. providing a web-based account-manager module, which is hosted on the central administrator's server, for creating and customizing client-specific eCRM interfaces;
e. accessing the account-builder module by each reseller to create an independent account-manager account for each of said reseller's clients;
f. for each reseller, providing each one of said reseller's clients with online access to said account-manager module; and
g. accessing said account-manager module by each client to create and customize said client's customer service interface,
thereby providing an automated distribution scheme for distributing said eCRM system from the central administrator to a plurality of clients through a plurality of resellers.

8. The method of claim 7, wherein the account-builder module is configured to enable each reseller to private label, customize, and integrate said account-manager module into web-based product packages and services that are offered by said reseller to the reseller's clients.

9. The method of claim 8, wherein the account-builder module further enables each reseller to administer and manage all of said reseller's account-manager client accounts.

10. The method of claim 9, wherein said account-builder module comprises a client-manager sub-module and a site-manager sub-module, said client-manager sub-module being adapted to enable management of the pricing for, and the number, status, and billing of each of said reseller's clients, and said site-manager sub-module being adapted to enable management of each reseller's web site.

11. The method of claim 10, wherein said eCRM system, including said account-builder and account-manager modules, are hosted substantially fully on one or more servers of the central administrator.

12. The method of claim 8, wherein said customization, private labeling, and integration are accomplished online, through a computer system of each respective reseller.

13. The method of claim 8, wherein said creation and customization of each client's eCRM interface are accomplished online, through a computer system of each respective client.
